(19) United States
(12) Patent Application Publication
(10) Pub. No.: US 2014/0265877 A1
(43) Pub. Date: Sep. 18, 2014

(54) LIGHTING CONTROL DEVICE AND METHOD

(71) Applicant: BARLING BAY, LLC, Charleston, SC (US)

(72) Inventors: Michael G. Joost, Charleston, SC (US); Douglas G. Benefield, Charleston, SC (US); Brad D. Smith, Charleston, SC (US)

(73) Assignee: Barling Bay, LLC, Charleston, SC (US)

(21) Appl. No.: 13/832,614

(22) Filed: Mar. 15, 2013

(51) Int. Cl. H05B 37/02

(52) U.S. Cl. CPC H05B 37/02
USPC 315/153; 315/294; 315/250

(57) ABSTRACT

A lighting control system and method. A plurality of light emitting devices, such as light emitting diodes, are controlled by a plurality of control units that comprise a receiver and a transceiver. A server communicates with each of the control units, and a signal is transmitted to and from the server to each of the control units by a conductor. The conductor provides electrical current to the light emitting devices and the electrical current powers the light emitting devices to emit light.

Applicant claims the benefit of Provisional Ser. No. 61/733,796 filed Dec. 5, 2012.

### FIELD OF THE INVENTION

The present invention relates to lighting controls generally, and is more specifically directed to a device and method for controlling and dimming multiple light emitting devices.

### BACKGROUND

Energy saving lighting strategies are desirable. In one example, large indoor spaces are illuminated by high bay light fixtures. Facilities using such fixtures include factories, warehouses, and auditoriums, among others. The existing fixtures often waste energy by providing large amounts of light at times and or in places where it is not needed. A factory floor may have several workstations that require a large amount of brightness during their operation. Any time the bright light is not actively being used by a worker, energy could be saved by reducing the light intensity in the room or at their particular workstation. Additional energy savings could also be obtained by actively controlling where the light is brightest in the room, while leaving all areas that do not need bright light in a lower power state. This type of control is the motivation for dimming capability, and for controllability of individual light fixtures. Making use of sunlight entering a space by reducing the light output from fixtures accordingly achieves the same goal.

Energy savings introduced by this light fixture have a potentially huge impact on total energy use in lighting interior spaces. The market that currently uses high bay fixtures is vast, and the United States government makes up a large part of it. Large scale adoption of light sources that employ energy saving techniques could result in significant long term cost reductions for their users. The potential drawback to this strategy is the initial cost of large scale replacement of currently existing technology. The importance of the goal of reducing unnecessary energy usage will help to motivate the use of the technology.

The goal of imminent bulb failure detection has an impact on maintenance techniques, including predictive maintenance. Current common maintenance techniques used for light sources in large spaces are corrective, and in some cases, preventative maintenance. Scheduling bulb replacements for bulbs that are likely to fail soon, instead of replacing any individual failed bulbs as necessary, or replacing bulbs after a set permitted lifespan, reduces costs for the user.

In December 2007, the United States government enacted the Energy Independence and Security Act, which requires that all general purpose light bulbs that produce 310-2600 lumens of light to be 30% more energy efficient than incandescent bulbs by 2014. A second stage of restrictions is to become effective by 2020 which requires all general-purpose bulbs to produce at least 45 lumens per watt, which is similar to CFL bulbs. These requirements are internationally supported and are put in place to eventually phase out all incandescent light bulbs and replace them with alternatives like CFLs and light emitting diodes (LEDs). However, these alternates are not ideal lighting solutions. CFLs contain mercury, which is a health hazard if the bulbs break, and have poor lighting quality and color rendition. LEDs have pinpoint light, which also yields an unnatural lighting quality, they are comparatively much more expensive, and they contain small levels of arsenic.

### OBJECTS OF THE INVENTION

It is desirable to
Obtain equivalent brightness to current fixtures.
Control multiple fixtures through a single command interface
Detect the failure of a light emitting device and report it to the controller for corrective maintenance
Use expected light emitting device lifetime data to report possible imminent light emitting device failure(s) to the user for preventive maintenance
Monitor ambient lighting conditions and automatically adjust fixture light output to deliver constant interior luminescent levels
Power is preferred to be provided by standard power supplied to buildings
Control is provided through existing building wiring
Use multiple light emitting devices to achieve variable brightness levels

### DESCRIPTION OF THE DRAWINGS

FIG. 1 is a graph showing a comparison of efficiency to frequency of pulse width modulation.

FIG. 2 is a graph showing a comparison of efficiency to duty cycle.

FIG. 3A is a schematic of an embodiment of the invention.

FIG. 3B is a schematic of another embodiment of the invention.

FIG. 4 is visual representation of an embodiment of a daylight harvesting process as perceived by a fixture's control unit.

FIG. 5 is a screen capture of light emitting device failure as reported by control units.

FIG. 6 is an embodiment of a failure detection circuit.

FIG. 7 is an annotated screenshot of messaging provided from control units to a central unit and displayed on a computer screen.

### DESCRIPTION OF PREFERRED EMBODIMENTS

In lighting environments in common use, such as warehouse environments, lighting may be provided by 400 Watt, Metal Halide Pulse Start (PS) light bulbs and bases, such as used with OSRAM™ High Bay lights. Bulbs of this type have a substantial warm up time, such as about 2-3 minutes from powering, until the bulbs reach maximum brightness. The bulbs may have a hot restart time of about 4-6 minutes from power down until cool enough to be powered on again. The average light output is between 28,500 and 33,000 lumens. A large amount of energy is consumed during the startup phase of this bulb and the bulb cannot be dimmed. Table 1 contains specifications for the 400 W light bulb:

TABLE 1
Prosrom 400 W bulb

| Nominal Wattage | 400 | W | Color Temperature | 3700-4000 | K |
|---|---|---|---|---|---|
| Nominal Voltage | 110 | V | Color Rendering | 65-70 | |
| | | | Index | | |
| Warm Up Time | 2-3 | min | Hot Restart Time | 4-6 | min |

In an exemplary embodiment of the present invention, multiple OSRAM Halostar Eco 50 W bi-pin halogen light bulbs are used in place of a 400 W metal halide bulb. Halogen bulbs are desirable because they are dimmable, have a significantly better Color Rendering Index, have comparable efficiencies to Compact Florescent Lamps (CFLs), and contain no mercury. Table 2 contains specifications of an OSRAM bulb.

TABLE 2
OSRAM 50 W Halostar bulb

| Nominal Wattage | 50 | W | Rated number of | 1,000,000 at | |
|---|---|---|---|---|---|
| | | | switching cycles | 1 s on/1 s off | |
| Nominal Voltage | 12 | V | Rated Lamp Lifetime | 4000 | hrs. |

| | | | | |
|---|---|---|---|---|
| Power Factor λ | 1.00 | Color Temperature | 3000 | K |

| | | | | |
|---|---|---|---|---|
| Nominal Luminous | 1180 | lm | Rated color rendering | 100 |
| Flux | | | index Ra | |

In a preferred embodiment, communication over power lines is used. Communication may be transmitted over existing building wiring. Communication signals are transported over switched leg circuits in both directions. This means of signal transmittance may be utilized with any light emitting device but dimming may not be feasible with a CFL bulb. Each fixture contains a node, which is an intelligent control device and transmits information to other nodes. Large networks of up to 10¹⁹ nodes can be supported using Echelon LonWorks™. Data packages can be up to 255 bytes long and transmitted at 4 kilobits/sec. Components of the Echelon LonWorks package may include a Neuron 3120, 3150, or 3170 microprocessor, twisted pair transceiver and control module, along with the power line transceiver, which gives the communication method greater flexibility.

A Neuron microprocessor may be programmed with a variant of the C programming language created known as Echelon Neuron C™. The language includes many standard ANSI-C libraries, and a variety of its own data structures and functions.

The efficiency of a light source is a function of the light that it produces and the energy it requires to operate. For the purposes of this specification, efficiency is defined as light output per power consumed. A unit of luminance may be defined as LUX, or lumens per square meter. The units of efficiency used in this document are LUX per Watt (LUX/W).

One mechanism to manipulate the luminance of a non-florescent light source involves modulating the power applied to the light source. The most common method is to use Pulse Width Modulation (PWM), effectively turning the power to the light source on and off rapidly. Power and luminance of the 50 W bulb changed when the frequency of the PWM was varied. The test determines how much added power is drawn by switching the bulb on and off. A program varies the period between 2 and 30 milliseconds for a frequency range of 33.3 to 500 Hz. In a darkened room, the luminance of the bulb is measured from one foot away with a Lutron LX-102 Light Meter, and correlated with the frequency of a 50% duty cycle square wave sent to the bulb. The power drawn by the bulb is measured using a P4400 Kill-a-Watt power meter, and efficiency is calculated (LUX/W). Power draw and luminance at frequencies for this example are given in Table 3.

TABLE 3
Power draw, luminance, and efficiency at
each PWM frequency for the 50 W bulb.

| Frequency | Power | I luminance | Efficiency |
|---|---|---|---|
| (Hz) | (W) | (LUX) | (LUX/W) |
| 500 | 26 | 38 | 1.4615 |
| 250 | 26 | 39 | 1.5 |
| 166.67 | 26 | 39 | 1.5 |
| 125 | 26 | 39 | 1.5 |
| 100 | 26 | 39 | 1.5 |
| 83.33 | 26 | 39 | 1.5 |
| 71.43 | 26 | 39 | 1.5 |
| 62.5 | 26 | 39 | 1.5 |
| 55.6 | 26 | 39 | 1.5 |
| 50 | 26 | 39 | 1.5 |
| 45.45 | 26 | 40 | 1.5385 |
| 41.67 | 26 | 40 | 1.5385 |
| 38.46 | 26 | 40 | 1.5385 |
| 35.71 | 26 | 40 | 1.5385 |
| 33.33 | 26 | 41 | 1.5769 |

Higher efficiency occurs at lower frequencies. PWM, if applied, should cycle the bulbs at a low rate. To avoid flickering in the bulbs, cycling is above the detection threshold of the human eye, which is generally above 30 Hz (this is dependent on the physics of the light source—the frequency tends to be higher for an LED source and lower for a Ω source). Power and luminance measurements taken at a fixed frequency determine the bulb performance at different duty cycles.

A computer program varies the duty cycle of a 100 Hz square wave from 0 to 100 percent in increments of 10 percent. The luminance of the bulb is measured 1 foot from the bulb and the power was measured using a P4400 Kill-a-Watt power meter. Using the measured luminance and power output, efficiency of the bulb at each duty cycle is calculated. Efficiency and duty cycle have a linear relationship, just as power and duty cycle. Therefore, to maintain the efficiency of the bulbs, it is desirable to maintain high duty cycles.

Several mechanisms may be used to manage PWM in a multi light capsule (bulb) environment. PWM may be achieved by alternating the on and off cycles of a plurality of bulbs, or by turning all of the bulbs on and off together. Theoretically, by turning the bulbs on and off at the same time, the power supply will be loaded on and off in a square wave pattern. When bulbs alternating between 1 bulb, or set of bulbs, are powered on and a second bulb, or set of bulbs of equal number, is powered off, the power load should remain relatively constant. Ideally, both of these methods should produce the same amount of light and have equivalent power draws. This test quantitatively determines a difference in the power draw of the bulb when the load on the power supply is varied, and comparing relative efficiencies.

A computer program provides control signals to a set or bank of two separate halogen bulbs. The setup either drives one bulb constantly at its recommended power settings, as a control, or alternates power to two bulbs being pulse width modulated at a 50% duty cycle to synchronize the two cycling bulbs. Power draw as measured using a P4400 Kill-a-Watt power meter in each test circumstance was recorded in Table 4 below.

TABLE 4
Voltage, current, light output, power drawn, and efficiency for a constant
load and for three different variations of a switching load.

| | Voltage | Current | | Power | Efficiency |
|---|---|---|---|---|---|
| | (V) | (Amps) | LUX | (W) | (LUX/W) |
| Constant Load (1 bulb, | 11.5 | 2.96 | 154 | 34.04 | 4.5 |
| 100% duty cycle) | | | | | |
| Switching Load (2 bulbs, | 11.2 | 4.75 | 66 | 53.2 | 1.2 |
| 50% Duty Cycle, Alter- | | | | | |
| nating) | | | | | |
| Switching Load (2 bulbs, | 10.5 | 4.49 | 46 | 47.15 | .98 |
| 50% Duty Cycle, Syn- | | | | | |
| chronized) | | | | | |
| Switching Load (1 bulb, | 11.2 | 2.39 | 38 | 26.77 | 1.4 |
| 50% Duty Cycle) | | | | | |

The power draw of a single bulb on for 100% of the time was notably lower than that of two alternating bulbs with 50% duty cycles (the same equivalent on time), and the power draw of a single pulse width modulated bulb was approximately half of two of them being alternated. This gives way to the efficiency of 1 bulb constantly loaded being higher than all of the switching load tests. The alternating switching load has a higher efficiency than the synchronized load because more power is being used at a single instant to turn on both bulbs when they are synchronized. The switching load with one bulb on at 50% has the second highest efficiency because it requires a current surge in between the synchronous and asynchronous two-bulb tests. These results are corroborated by theoretical analyses of an idealized light circuit and can be explained by the nonlinear resistance shown by a filament as it is heated to produce light. This leads to the conclusion that, while PWM is certainly effective as a means to manage the light output of a fixture, if there are multiple resistive filament light emitting devices (e.g. Halogen or incandescent) in a fixture, greater overall efficiency (in terms of LUX/W) can be achieved by running some light emitting devices at their designed rating while others in that fixture are tuned off resulting in reduced overall light output at highest efficiency. This analysis does not hold for LED or other non-thermal light sources. PWM may still be a very efficient means to control the light output of an LED light source.

In one embodiment, control of eight 50 W light emitting devices is used to match the current power draw of the 400 W high bay fixture. Dimming, daylight harvesting, failure detection, and failure prediction are implemented using a controller that manages, for example, eight halogen light capsules, an analog to digital converter (ADC), and ambient light sensors. FIG. 3A and FIG. 3B show block diagrams for embodiments of the invention

In one embodiment an Echelon processor receives messages from a server through the power lines with a specific message code and data field and interprets the code to determine the required action to perform through the light emitting device activation circuitry or ADC. These actions are controlled by a control program inserted into the Echelon chip. The control program may comprise the following functions:
Maintenance of light emitting device status—the firmware maintains several global variables providing information about the state of each light emitting device (on or off), and whether the light emitting device is healthy, failing or failed, with the information updated on a regular schedule.
Usage leveling—a light emitting device cycling manager manages activation and deactivation of the light emitting devices according to an ordered queue structure; a light emitting device just being turned off goes to the end of the queue of light emitting devices to be turned on, and a light emitting device just turned on goes to the end of the queue of light emitting devices to be turned off.
Failure detection—a scheduled monitor that, on a regular interval, examines each of the light emitting devices for failure and updates a global variable representing the state of overall light emitting device health.
Failure notification—a scheduled process to send failure notification messages to the server. For each unhealthy or failing light emitting device, the controller sends a message to the server that informs the user that a failure has occurred or is likely to occur.
Failure replacement—a manager that executes whenever a light emitting device is to be turned on. If that light emitting device has a failed status, the next light emitting device from the queue of light emitting devices to be turned on will be turned on.
Received message handler—receives messages from the server and executes the request. These messages include:
   Discrete output mode—when discrete output is desired, the server specifies the setpoint (percentage of maximum output the fixture is to provide—0%, or off, to 100%). This output is fixed until the next change initiated from the server.
   Daylight harvesting mode—when daylight harvesting is turned on, the fixture monitors the ambient level of light. If the current level is greater than the setpoint, light emitting devices are turned off until the setpoint is reached or all are off. Conversely, if the current level is below the setpoint, light emitting devices are turned on until the setpoint is reached or all are on.

While many of the high bay fixtures currently implemented in factories provide light in a setting where little natural light occurs, some high bay fixtures are used to complement lighting from other sources, such as the sun. In these settings, it is most desirable to have a constant source of light that needs little to no adjustment during the day, and is energy efficient. This invention uses phototransistors to monitor the light level reflected back to the fixture and adjust the number of active light emitting devices to take advantage of, or “harvest”, the natural daylight in any given environment.

In one embodiment, two phototransistors sample luminance at each fixture. The phototransistors act as photo sensors with a variable voltage output proportional to the amount of light received. The photo sensors may be mounted on an inner edge of a fixture cone to capture reflected light. In an embodiment, eight light emitting devices are mounted deeper in the cone. An analog-to-digital converter (ADC) transforms the output voltage from the phototransistors into a digital stream of data read by the PL3170 microcontroller to quantify the amount of light at the point of the phototransistor. The higher of the two readings is chosen to represent the brightness of the room. This value is compared to the desired light level set by the user through a brightness slider displayed on the user interface, if accessed by a browser, or exposed to control by third-party software. When the user presses the button to activate daylight harvesting, the controller samples the current light level from the phototransistors and stores that value as a reference for future comparisons.

The controller may poll the phototransistors through the ADC at regular intervals to determine the light level at that time. If the measured value is below a threshold based on the previously set target brightness level, the controller automatically actuates additional light emitting device(s) to compensate as needed. Conversely, if the measured brightness level is above the target threshold, the controller terminates actuation of the light emitting devices until the sampled brightness level is within the desired range.

The phototransistors are affixed directly to the rim of the fixture cone. This location allows for simple and accurate readings of light levels being received at the rim of each fixture, High bay fixtures are generally set fifteen to twenty feet off the ground, and thus the brightness levels measured at the working level would be expected to be different than the current readings taken directly on the fixture. However, since the light being measured is the light arriving at the fixture, not the light being generated by the fixture, it can reasonably be assumed that the light received is proportional to the light at the work surface. It's important to note that in some applications, where greater accuracy of the surface illumination is required, additional phototransistors may need to be placed closer to ground level and these may be interfaced to the same controller on the fixture.

A visual representation of an embodiment of the daylight harvesting process as perceived by the fixture's control unit is shown in FIG. 4. Each diamond shaped dot in FIG. 4 represents a sample of the output of the photo sensors mounted on the fixture cone. The central dashed line indicates the target brightness level set when the user enables daylight harvesting at time zero. After enabling daylight harvesting, each of the first three samples of the photo sensors results in a slightly higher brightness reading, due to some sort of outside light source such as sunlight. Once the measured brightness level exceeds the high threshold limit indicated by the upper dashed line, the control unit responds by turning off a light emitting device to restore the fixture brightness to a brightness within the target threshold. The large diamond at 2 minutes represents the photo sensor reading outside the threshold and corresponds to the need to turn a light emitting device off. After turning off a light emitting device, the subsequent brightness level readings are within the target threshold, and the status of the light emitting devices is not further changed by the controller until brightness levels change.

The failure of a filament-based light emitting device is characterized by the physical breakage of the filament at some point along its length within the light emitting device. From an analog circuit analysis perspective, this manifests as the creation of an open circuit in place of the light emitting device. This embodiment takes advantage of this failure effect by placing a voltage divider resistor network with high resistance components in parallel with the light emitting device activation circuitry transistor (FIG. 6). This two-resistor network facilitates analog voltage readings at its middle node within the operating range of an ADC without creating a significant leakage current in the circuit. When a healthy light emitting device is set to its off configuration, the voltage at the sampling node is consistently and accurately distinguishable from the voltage level of a failed light emitting device sampled at the same spot.

The ADC is used to convey the voltage level information to the power line chip via an SPI connection. Each light emitting device activation circuitry is read by one channel of the ADC. Once the voltage level at the sampling node of a given light emitting device circuitry has been read, the output of the ADC is processed to extract the numerical voltage level, and this level is compared to a constant threshold value. If the read and processed voltage exceeds the threshold, the corresponding light emitting device is declared healthy. Otherwise, it is marked as failed.

FIG. 7 shows an annotated screenshot of the final layout for an exemplary user interface. Each highlighted box corresponds to a specific development area of the system's functionality and details for each section are given below.

Commands sent to the process executing on the Echelon processor from the server are sent using a communication such as Echelon LonTalk power line communication protocol, which supports various message types for message transfers between network devices. Messages on the LonTalk protocol feature a message code and data field, and commands are directed from the server to a given control unit (or fixture) by addressing the messages either implicitly or explicitly.

Depending on the function desired at the fixture (such as turning on four light emitting devices or turning off all light emitting devices), the server selects the appropriate message data field from a range of codes that are pre-defined in the messaging function of the software executing on the server. The Echelon network interface then sends a message, with the specified Neuron ID (which is unique to each fixture) containing that data field and corresponding message code. The firmware on the Echelon processor contains a method for receiving and interpreting various message types, and it parses the message code and data received from the server to determine the appropriate action to carry out. Table 5 provides a summary of the message codes and corresponding Echelon firmware actions that may be implemented.

TABLE 5
LonTalk Message Code Association

| Message Code | Command |
|---|---|
| 0 | All lights OFF |
| 1 | 1 light emitting device ON |
| 2 | 2 light emitting devices ON |
| 3 | 3 light emitting devices ON |
| 4 | 4 light emitting devices ON |
| 5 | 5 light emitting devices ON |
| 6 | 6 light emitting devices ON |
| 7 | 7 light emitting devices ON |
| 8 | 8 light emitting devices ON |
| 15 | Response Request |
| 20 | Enable Daylight Harvesting |
| 21 | Disable Daylight Harvesting |

All of the messages sent from the server to the Echelon processor using the codes above in Table 5 are classified as application messages within the LonTalk protocol. As such, the unique message codes are necessary to allow the control unit at the fixture to distinguish between different commands from the server. An application message traveling in the other direction (from the Echelon processor to the server) may be used for light emitting device failure detection. In this case, the message code of the incoming message at the server is not one of the codes specified above; it is the byte of light emitting device failure information. Firmware may be used to process different message codes and data.

To provide a large-scale setting with multiple fixtures, each controlling a set of, for example, eight light emitting devices, a grouping routine was established in the server allowing a user to create a group of fixtures, sending the same command to multiple fixtures. The server may iterate through fixtures in a group, sending the same message to every fixture when the group's status changes. This functionality is useful if many fixtures are in a small area and/or operating under similar conditions and the user does not want to have to manually send the same command to this large number of devices, such as reducing the brightness level in a group of rooms, or turning off lights in an unused area of a warehouse. The user interface executing on the server may contain a button and form that allows the user to add or edit a group of fixtures, which provides a list of connected Neuron IDs (i.e. the ID of the chip in the local fixture controller) when clicked, and allows the user to select multiple IDs to be part of a group. The user can also name the group after it has been created.

To control the brightness level for a selected fixture or group of fixtures, a control such as a slider bar may be implemented in the user interface executing on the server. The control may provide multiple brightness levels, such as eight discrete brightness levels. The control allows the user to select brightness levels from 0-100% in increments, such as 12.5% increments, with each increasing brightness value corresponding to an additional light emitting device turning on when 8 light emitting devices are used, or 10% increments if 10 light emitting devices are used. The user may choose a desired brightness level via the control, or manipulate the control, such as by sliding the level indicator from its current value to a desired level. Once a change is made to the position of the brightness indicator, the server fetches the new position of the control and calculates the corresponding change command. It then creates a message with the code and data fields associated with the determined command and calls the messaging function, which relays the message to the selected fixture or group of fixtures.

In one embodiment, the user interface executing on the server may contain a control, such as a button to enable daylight harvesting, causing the server to send a message to the fixture controller with a code and data field, which the controller interprets as a daylight harvesting request. The control sets the daylight harvesting system into its enabled state, sets the target light level, and periodically samples the lighting level for comparison to the target. Any changes made to the brightness control while daylight harvesting is enabled are treated as a new desired brightness value, and the controller samples phototransistors and adjusts brightness levels as disclosed above.

In an embodiment, the ADC samples voltage in each dimming circuit periodically to determine if light emitting device failures have occurred. The fixture controller compares sampled voltage readings with threshold levels for each possible light emitting device status (on, off, failed) to determine the health of each light emitting device on the fixture. If a failure is detected, the controller sends a message addressed explicitly to the server. The server may then process that message and display a text label indicating that one or more failures have been detected. A control such as a button may be displayed to enable detailed failure information to be displayed to the user. When clicked, the button pops up a new window that contains a text box populated with the device ID and light emitting device number for each failure detected and a timestamp indicating the date and time the failure message was received. A screen capture of this form is given in FIG. 5. This form may further provide an option for user to save the failure information to a text file and associate it with the devices and/or groups from which the failure(s) originated. The failure detection label and window display button may not be visible on the server screen until the fixture controller sends a message to the server containing the appropriate data field to indicate at least one light emitting device has failed.

Control functions of the light emitter/light emitting device are provided at the lighting level, which means that there is not a traditional light switch. Each light emitter has a unique address that is responsive to a unique signal which may be transmitted over the power line, and managed at a server. In a preferred embodiment, each light emitter has an associated control unit comprising a transceiver that receives and transmits signals, including the status of the light emitter.

What is claimed is:

1. A lighting control system, comprising:
a plurality of light emitting devices;
a plurality of control units, with each of the plurality of control units corresponding to one of the light emitting devices and each of the plurality of control units controls a corresponding light emitting device, wherein each of the plurality of control units comprises a receiver and a transceiver;
a server that communicates with each of the control units; wherein a signal is transmitted from the server to each of the plurality of control units by a conductor, and a signal is received from each of the plurality of control units by the conductor, and wherein the conductor provides electrical current to the plurality of light emitting devices and the electrical current powers the light emitting devices to emit light.

2. A lighting control system as described in claim 1, wherein each of the control units has a unique address, wherein the unique address responds to a unique signal for the unique address, and wherein the unique signal is transmitted from the server to each of the control units by the electrical conductor.

3. A lighting control system as described in claim 1, wherein each of the plurality of control units comprises a transceiver that transmits a signal from each of the plurality of control units to the server.

4. A lighting control system as described in claim 1, wherein each of the plurality of control units comprises a transceiver that transmits a signal from each of the plurality of control units to the server, wherein each of the control units has a unique address, wherein the unique address responds to a unique signal for the unique address, and wherein the unique signal is transmitted to and from the server to and from each of the control units by the electrical conductor.

5. A lighting control system as described in claim 1, wherein the plurality of light emitting devices, the plurality of control units and the server communicate by a common circuit.

6. A lighting control system as described in claim 1, wherein light intensity for each of the plurality of light emitting devices is variable independently from other light emitting devices of the plurality of light emitting devices, and wherein light intensity for each of the plurality of light emitting devices is controlled by a corresponding control unit according to a signal received from the server.

7. A lighting control system as described in claim 1, wherein a status of the plurality of light emitting devices is communicated by the plurality of control units to the server unit by the conductor.

8. A lighting control system as described in claim 1, wherein a status of the plurality of light emitting devices is communicated by the plurality of control units to the server unit by the conductor, and wherein the status includes the operational condition of each of the plurality of light emitting devices.

9. A lighting control system as described in claim 1, wherein a status of the plurality of light emitting devices is communicated by the plurality of control units to the server unit by the conductor, and wherein the status includes the operational condition of each of the plurality of light emitting devices, and upon a report of an inoperable light emitting device of the plurality of light emitting device, another light emitting device of the plurality of light emitting devices is actuated.

10. A lighting control system as described in claim 1, wherein a status of the plurality of light emitting devices is communicated by the plurality of control units to the server unit by the conductor, and wherein the status includes the operational condition of each of the plurality of light emitting devices, and wherein the control unit stores the aggregate time that each of the plurality of light emitting devices is operational.

11. A lighting control system as described in claim 1, wherein a status of the plurality of light emitting devices is communicated by the plurality of control units to the server unit by the conductor, and wherein the status includes the operational condition of each of the plurality of light emitting devices, and wherein the control unit stores the aggregate time that each of the plurality of light emitting devices is operational, and the control unit comprises a programmable algorithm that communicates with an alerting device that indicates an end of a replacement cycle.

12. A lighting control system as described in claim 1, wherein the each of the plurality of light emitting devices is powered by alternating current.

13. A lighting control system as described in claim 1, wherein the each of the plurality of light emitting devices is powered by alternating current, and each of the plurality of light emitting devices is mounted in a building.

14. A lighting control system as described in claim 1, further comprising a device for measuring ambient light, wherein the plurality of control units vary a level of light emission for an associated light emitting device of the plurality of light emitting devices based upon an reflected light measurement.

15. A lighting control system as described in claim 1, further comprising a plurality of sensors, wherein each sensor of the plurality of sensors measures reflected light, and each sensor communicates a measurement of reflected light to an associated control unit of the plurality of control units.

16. A lighting control system as described in claim 1, wherein a plurality of control units has a unique address, wherein the unique address responds to a unique signal for the unique address, and wherein the unique signal is transmitted from the server to each of the plurality of control units by the electrical conductor.

17. A lighting control system as described in claim 1, wherein a first plurality of control units comprises a first unique address, wherein the first unique address responds to a first unique signal for the first unique address, and wherein the first unique signal is transmitted from the server to each of the first plurality of control units by the electrical conductor, and a second plurality of control units has a second unique address, wherein the second unique address responds to a second unique signal for the second unique address, and wherein the second unique signal is transmitted from the server to each of the second plurality of control units by the electrical conductor.

18. A lighting control system as described in claim 1, wherein a status of the plurality of light emitting devices is communicated by the plurality of control units to the server by the conductor, and wherein the status includes the operational condition of each of the plurality of light emitting devices, and wherein the control unit stores the aggregate time that each of the plurality of light emitting devices is operational, and the control unit comprises a programmable algorithm that communicates with an alerting device that indicates an end of a replacement cycle, wherein the status is communicated by the plurality of control units in response to a query from the server and the status is reported periodically by the plurality of control units.
